(19) United States
(12) Patent Application Publication
(10) Pub. No.: US 2008/0034938 A1
(43) Pub. Date: Feb. 14, 2008

(54) Connecting link for a saw chain

(75) Inventor: Alexander Fuchs, Bietigheim-Bissingen (DE)

Correspondence Address: WALTER OTTESEN, PO BOX 4026, GAITHERSBURG, MD, 20885-4026, US

(73) Assignee: Andreas Stihl AG & Co. KG.

(21) Appl. No.: 11/826,543

(22) Filed: Jul. 17, 2007

(30) Foreign Application Priority Data
Aug. 10, 2006 (DE) 10 2006 037 330.8

(51) Int. Cl. B27B 33/14

(52) U.S. Cl. 83/830

(57) ABSTRACT

A connecting link (4, 34) for a saw chain (1) of a motor-driven chain saw has an areal base body (24) which has two rivet openings (12, 15). The connecting link (4, 34, 44) has a longitudinal center axis (11) which intersects the axes (13, 16) of rivet openings (12, 15) and runs in the base body (24). The functional regions of the connecting links (4, 34, 44) are mirror symmetrical to planes (32, 36), which contain the longitudinal center axis (11), and are unsymmetrical to each plane perpendicular to the longitudinal center axis (11). In this way, the connecting link (4, 34, 44) can be arranged on both longitudinal sides of the saw chain (1).

### CROSS REFERENCE TO RELATED APPLICATION

This application claims priority of German patent application no. 10 2006 037 330.8, filed Aug. 10, 2006, the entire content of which is incorporated herein by reference.

### BACKGROUND OF THE INVENTION

U.S. Pat. No. 6,837,138 discloses a saw chain having an even connecting link having two rivet openings. The running surfaces have different lengths so that the connecting link has to be assembled into the saw chain with the proper orientation. Saw chains of this kind have a bevel on the side of rivet opening directed outwardly and the head of the rivet is partially arranged in this bevel. Since the bevel must face outwardly, the connecting link can only be assembled on one longitudinal side of the saw chain. Different connecting links must be provided for both longitudinal sides and this makes the manufacture and assembly complex.

### SUMMARY OF THE INVENTION

It is an object of the invention to provide a connecting link of the kind described above which simplifies the assembly and manufacture of a saw chain.

The connecting link of the invention is for a saw chain of a motor-driven chain saw. The connecting link includes: a flat base body having first and second rivet openings defining first and second rivet opening axes; the flat base body defining a longitudinal middle axis running through the flat base body and intersecting the first and second rivet opening axes; the longitudinal middle axis and the first and second rivet opening axes conjointly defining a plane; and, the flat base body having functional regions mirror symmetrical to the plane.

The symmetrical configuration of the functional regions of the connecting link makes it possible to arrange the connecting link on both longitudinal sides of a saw chain. The connecting link is configured symmetrically to a plane, which contains the axes of the rivet openings, or to a plane which is perpendicular to the axes of the rivet openings. It is essential that the functional regions of the connecting link are configured so as to be mirror symmetrical. Regions, which have no function, can be configured unsymmetrically. The functional regions include the rivet openings and the running surfaces of the connecting link. The base body of the connecting link also defines a functional area insofar as it lies on a neighboring link of the saw chain. Depressions in the base body can, however, also be arranged unsymmetrically because these depressions do not affect the function of the surface of the base body, namely, the contact engagement against a neighboring link of the saw chain.

To make possible an arrangement of the connecting link on both longitudinal sides of the saw chain, it is especially provided that the rivet opening has respective bevels on an outer side and on an inner side of the connecting link and that the widths of the two bevels of the rivet opening are the same size with the width being measured parallel to the axis of the rivet opening. In this way, the connecting link can be arranged on the opposite-lying side of the saw chain so that the outer side faces toward the inner side of the saw chain and the inner side faces outwardly. Inner sides and outer sides are especially configured to be identical. The connecting link is advantageously configured to be mirror symmetrical to a plane perpendicular to the axes of the rivet openings.

It can, however, be provided that the connecting link is configured to be mirror symmetrical to a plane containing the longitudinal center axis and the axes of the rivet openings. Accordingly, the connecting link has a contour on the upper end which likewise has running surfaces. In a connecting link wherein the elevation in the region of the trailing rivet opening is less than the elevation in the region of the leading rivet opening, a lower elevation of the connecting link results in the region of the trailing rivet opening because of the mirror symmetrical configuration. For a connecting link which is arranged next to a cutting link, the chip channel is increased by the reduction of the elevation of the connecting link at the trailing rivet opening. The chip removal is improved.

Because of the mirror symmetrical configuration, the connecting link can be arranged on both longitudinal sides of the saw chain by a rotation of 180° about the longitudinal center axis. The symmetrical configuration leads to a uniform loading of the connecting link because, with tension stresses (that is, stresses in the running direction of the saw chain or in the longitudinal direction of the saw chain), the same stresses arise above and below the symmetry plane. In this way, bending forces are avoided. Advantageously, the rivet opening has a countersink on an outer side of the connecting link and a bevel on an opposite-lying inner side. The width of the countersink, which is measured parallel to the axis of the rivet opening, is greater than the width of the bevel. The head of a rivet is arranged in the countersink. The bevel ensures only the deburring of the rivet opening on the opposite-lying inner side of the connecting link. With the mirror symmetrical configuration of the connecting link, the outer side of the connecting link faces outwardly, independently of on which longitudinal side of the saw chain the connecting link is mounted. In this way, the countersink can be configured to be comparatively large whereas the width of the bevel can be very narrow. However, bevels of the same width can be provided on both longitudinal sides. In this way, the connecting link can be configured to be symmetrical to a plane containing the longitudinal center axis and lying in the plane of the connecting link as well as be symmetrical to a second plane which contains the longitudinal center axis and the axes of the rivet openings.

Advantageously, the connecting link has a smaller elevation in the region of the rivet opening leading in the running direction than in the region of the trailing rivet opening with this elevation being measured perpendicularly to the axis of the rivet opening and to the longitudinal center axis. In this way, the vibrations of the saw chain developing during operation are reduced. In the region lying between the rivet openings, the connecting link has especially an elevation which is less than the elevation in the region of the leading rivet opening and less than the elevation in the region of the trailing rivet opening. The reduced elevation in the region between the rivet openings permits small direction-changing radii of the saw chain. The strength is reduced because of the lesser elevation and this can be countered by the arrangement of an impression. The connecting link has a forward running surface next to the leading rivet opening and a rearward running surface next to the trailing rivet opening. The length of the rearward running surface is greater than the length of the forward running surface. During operation, greater forces act at the rearward running surface. The wear-caused material removal at the rearward running surface is reduced because of the lengthening of the rearward running surface. The rearward running surface is advantageously so measured with respect to the forward running surface that the wear-caused material removal is approximately the same at both running surfaces during operation.

It is practical that the forward-running surface runs parallel to the longitudinal center axis. The forward running surface and the rearward running surface conjointly define an angle. The angle preferably opens rearwardly referred to the running direction. The angle between the-forward and rearward running surfaces reduces the vibrations of the saw chain occurring during operation because a connecting link, which is so configured, permits a slight tilting of a cutting link when the cutting link comes into contact with the workpiece to be cut. The cutting link is arranged on the opposite-lying side of the connecting link. Advantageously, the angle is 1° to 5°. Low vibrations result especially at an angle of 2° to 3°. To permit a tilting during operation, it is furthermore provided that the maximum spacing of the forward running surface to the longitudinal center axis is greater than the maximum distance of the rearward running surface to the longitudinal center axis.

Advantageously, the upper side of the connecting link facing away from the running surfaces is even. The upper end advantageously runs parallel to the longitudinal center axis.

Advantageously, the connecting link has at least one depression on the base body. The depression on the base body defines no functional region of the connecting link and can therefore be configured to be unsymmetrical. The depression is especially so configured that it ensures the orientation of the connecting link in the pregiven direction. Advantageously, the depression is arranged in a region between the rivet openings and is configured as an impression in whose region the material of the connecting link is compressed. The impression between the rivet openings can be introduced simply into the connecting link. During the pressing process, the material in the region between the rivet openings is deformed and compressed. This leads to an increased strength in this region.

Advantageously, the impression is intersected by a plane which contains the axes of the rivet openings and the longitudinal center or middle axis. The impression is thereby arranged at the elevation of the rivet openings, that is, in a region subjected to intense mechanical load. Advantageously, the impression is in the form of an arrow head which points in the running direction of the connecting link. The connecting links are configured differently in the region of the leading rivet opening and in the region of the trailing rivet opening. The connecting link must therefore be assembled in the correct position. With the configuration of the impression in the form of an arrow head, the correct orientation of the connecting link is shown in a simple manner without additional means being necessary. In this way, the assembly is simplified. Also, for an exchange of the connecting link by the operator, a position-correct installation is ensured because of the impression. On each side of the base body, an impression is arranged and both impressions point in the same direction. In this way, in every built-in position, an impression points in the running direction so that the operator can easily control the position-correct installation.

However, it can also be provided that the recess is configured as a bevel. The bevel is arranged at an upper end of the base body of the connecting link and so permits a position-correct orientation for a connecting link which is configured symmetrically to a plane perpendicular to the axes of the rivet openings.

### BRIEF DESCRIPTION OF THE DRAWINGS

The invention will now be described with reference to the drawings wherein:

FIG. 1 is a side elevation view of a saw chain;

FIG. 2 is a side elevation view of a connecting link of a saw chain;

FIG. 3 is a schematic section view of the connecting link of FIG. 2 along the line III-III in FIG. 2;

FIG. 4 is a schematic section view taken along line IV-IV in FIG. 2;

FIG. 5 is a schematic section view taken along line III-III of FIG. 2 and shows an embodiment of a connecting link;

FIG. 6 is a schematic section view taken along line IV-IV of FIG. 2 for an embodiment of a connecting link;

FIG. 7 is a side elevation view of an embodiment of a connecting link;

FIG. 8 is a partially cut perspective view of the connecting link of FIG. 7;

FIG. 9 is an embodiment of a connecting link shown in a side elevation view;

FIG. 10 is a section view taken along line X-X of FIG. 9; and,

FIG. 11 is a partial section perspective view of the connecting link of FIG. 9.

### DESCRIPTION OF THE PREFERRED EMBODIMENTS OF THE INVENTION

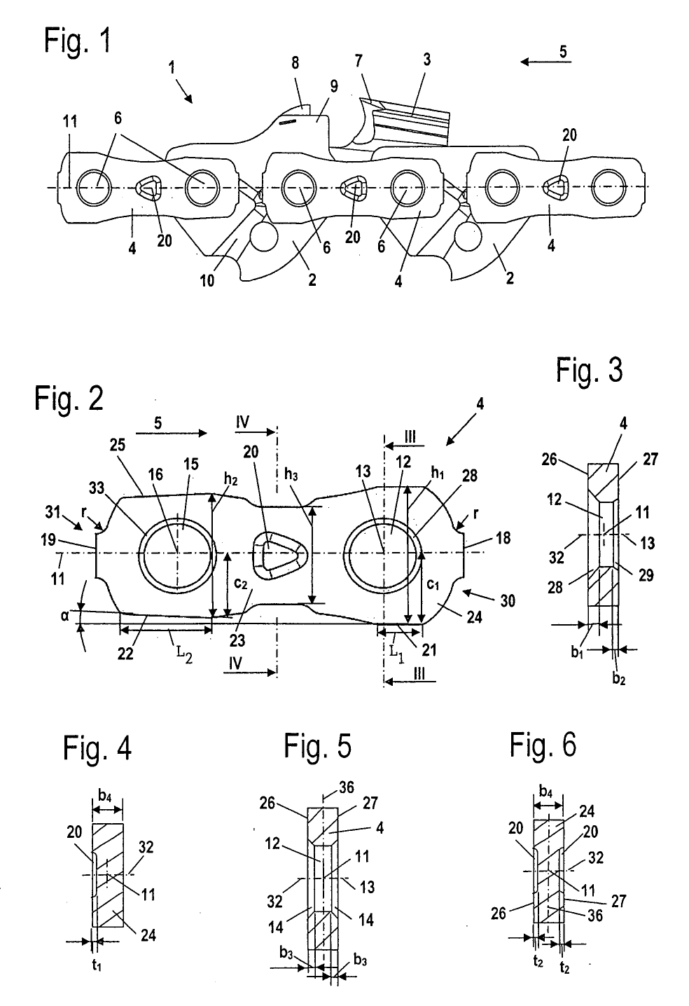

A portion of a saw chain 1 is shown in FIG. 1 and the saw chain is assembled of drive links 2, cutting links 3 and connecting links 4. The drive links 2, cutting links 3 and connecting links 4 are articulately connected to each other via rivet bolts 6. The drive links 2 are arranged in the center and connecting links 4 are provided at the outer sides of the drive links. The trailing rivet opening of a drive link 2 is connected to a forward rivet opening of a connecting link 4 and a forward rivet opening of a drive link 2 is connected to a rearward rivet opening of a connecting link 4. Viewed in a saw chain running direction 5, a cutting link 3 is arranged in lieu of a connecting link 4 every two connecting links 4. The cutting links 3 are provided alternately on respective longitudinal sides of the saw chain 1. The cutting links 3 have a cutting tooth 7 with a depth limiter 8 arranged forward thereof. A support protuberance 9 for reinforcing the depth limiter can be provided on a neighboring drive link 2 next to the depth limiter 8. The drive links 2 have a lubricating channel 10 which is connected to the openings of the rivet bolts 6 and via which the lubricating oil is conveyed to the rivet openings.

In FIG. 2, an enlarged connecting link 4 is shown. Referred to the running direction 5 of saw chain, the connecting link 4 has a leading rivet opening 12 having an axis 13 as well as a trailing rivet opening 15 having an axis 16. The connecting link 4 has an areal base body 24 wherein a longitudinal center axis 11 of the connecting link 4 lies. The longitudinal center axis 11 intersects the axes 13 and 16 of the rivet openings 12 and 15. The connecting link 4 has a middle region 23 between the two rivet openings (12, 15) wherein an impression 20 is arranged. The impression 20 is configured as a triangle with rounded corners and forms an arrow head which points in the running direction 5 of the saw chain.

As shown in FIG. 4, the impression 20 has a depth t₁ which corresponds to between 5% to 25% of a width b₄ of the base body 24 of the connecting link 4. The depth t₁ and the width b₄ are measured parallel to the axes 13 and 16 of rivet openings 12 and 15, respectively. The connecting link 4 has a plane 32 which contains the longitudinal center axis 11 and the axes 13 and 16 of rivet openings 12 and 15, respectively. The plane 32 intersects the impression 20 at the middle so that sections of the impression 20, which are arranged above and below the plane 32, are symmetrical to the plane 32. The impression 20 can, however, also be arranged or configured to be unsymmetrical to the plane 32.

The connecting link 4 has a forward running surface 21 having a length L₁ next to the leading rivet opening 12. The running surface 21 runs parallel to the longitudinal center axis 11 and to the plane 32 and, during operation, lies on a guide bar of a motor-driven chain saw. A rearward running surface 22 is provided next to the trailing rivet opening 15 and this rearward running surface 22 has a length L₂. The length L₂ of the rearward running surface 22 is longer than the length L₁of the forward running surface 21. The length L₂ of the rearward running surface can, advantageously, be 1.2 times to 2 times the length L₁ of the forward running surface 21. The rearward running surface 22 is inclined at an angle α relative to the forward running surface 21. The angle α opens opposite to the running direction 5 and can be 1° to 5° and especially 2° to 3°.

In the region of the forward running surface 21 and the leading rivet opening 12, the connecting link 4 has an elevation h₁, which is measured perpendicularly to the plane 32, and this elevation h₁ is greater than the maximum elevation h₂ of the connecting link 4 in the region of the rearward running surface 22. Because of the inclination of the rearward running surface 22, the elevation h₂ is measured in the forward region of the rearward running surface 22 whereat the maximum extent of the connecting link 4 lies perpendicularly to the plane 32. The center region 23 has an elevation h₃, which is measured perpendicularly to the plane 32, and this elevation h₃ is less than the elevation h₁ and the elevation h₂. The connecting link 4 has a constriction in the center region 23 whereat the impression 20 is arranged. Also, a distance c₁ between the longitudinal center axis 11 and the forward running surface 21 is greater than a distance c₂ between the longitudinal center axis 11 and the rearward running surface 22. The distance c₂ identifies the maximum distance between the longitudinal center axis 11 and the rearward running surface 22 perpendicular to the plane 32.

On the forward high end 30 referred to the running direction 5, the connecting link 4 has an edge 18 which is configured to be even and extends perpendicularly to the longitudinal center axis 11 and to the plane 32. On the rearward high end 31 referred to the running direction 5 of the saw chain, the connecting link 4 has a likewise even rearward edge 19 configured perpendicularly to the longitudinal center axis 11. Concave radii (r) extend at both ends from the two edges (18, 19). The forward high end 30 and the rearward high end 31 run arcuately in the region lying outside of the linear edges (18, 19) so that rounded high ends 30 and 31 result. The arcuate high ends (30, 31) are connected to edges (18, 19) via the concave radii (r).

As shown in FIG. 3, the rivet opening 12 has a countersink 28 on its outer side 26 which faces outwardly during assembly on a saw chain 1. The countersink 28 has a width b₁. The width b₁ is measured parallel to the axis 13 of the rivet opening 12. On the opposite-lying inner side 27, the rivet opening 12 has a bevel 29 having a width b₂. The width b₂ of the bevel 29 is considerably smaller than the width b₁ of the countersink 28. The width b₁ of the countersink 28 can, for example, amount to 1.5 to 8 times the width b₂. Advantageously, the width b₁ is more than 3 times the width b₂.

As shown in FIG. 2, the connecting link 4 is configured to be mirror symmetrical to the plane 32. The upper end 25, which faces away from the running surfaces 21 and 22, likewise has a contour with running surfaces and a constriction between the running surfaces. The trailing rivet opening 15 of the connecting link 4 has a countersink 33 which corresponds to the countersink 28 of the leading rivet opening 12. A bevel (not shown) is also provided on the opposite-lying inner side 27 at the trailing rivet opening 15.

In FIG. 5, a section through an embodiment of a connecting link 4 is shown. The rivet opening 12 has respective bevels 14 on the outer side 26 and on the inner side 27. The two bevels 14 have identical widths b₃ measured parallel to the axis 13 of the rivet opening 12. The rivet opening 12 with the two bevels 14 is configured mirror symmetrical to the plane 36. The trailing rivet opening 15 is configured identically. In this way, the functional regions of the connecting link 4, namely, the rivet openings, the bevels at the rivet openings as well as the running surfaces of the connecting link 4 are configured mirror symmetrically to the plane 32 as well as to the plane 36. The connecting link 4 can be arranged with the outer side 26 as well as with the inner side 27 on a drive link 2. The inner side 27 and the outer side 26 are configured identically.

As shown in FIG. 6, an impression 20 can be provided on the outer side 26 as well as on the inner side 27. The impressions 20 can also be configured to be symmetrical to the plane 36 and to the plane 32. The impressions 20 have respective depths t₂, which are measured perpendicularly to the plane 36, and which advantageously amount to between 5% and 25% of a width b₄ of the base body 24 of the connecting link 4. The impressions 20 are shown as recesses. For this reason, they define no functional region of the connecting link 4 and can therefore also be configured and arranged unsymmetrically to the plane 36 and/or plane 32.

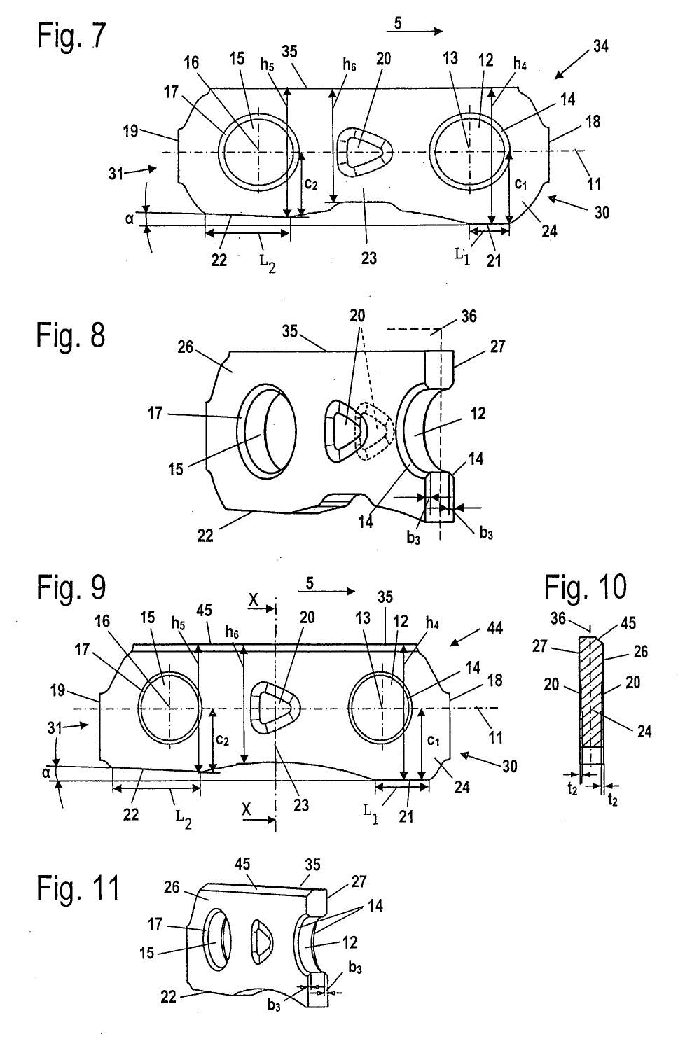

A further embodiment of a connecting link 34 is shown in FIG. 7. The configuration of the connecting link 34 corresponds essentially to the configuration of the connecting link 4 from FIGS. 1 to 4. The same reference numerals are used for the same elements. The connecting link 34 differs from the connecting link 4 from FIGS. 2 to 4 by the configuration of the rivet openings (12, 15). As also shown in FIG. 8, the leading rivet opening 12 has respective bevels 14 on the outer side 26 and the inner side 27. The bevels 14 have a width b₃ which is the same size on the outer side 26 and the inner side 27. The trailing rivet opening 15 has corresponding bevels 17 which have the same width on the outer side 26 and the inner side 27. The configuration of the rivet openings 12 and 15 of the connecting link 34 thereby corresponds to the configuration of the rivet openings of the connecting link 4 in the embodiment shown in FIGS. 5 and 6.

As shown in FIG. 7, the upper end 35 of the connecting link 34 is configured to be even. The upper end 35 lies facing away from the running surfaces 21 and 22. The upper end 35 runs parallel to the longitudinal axis 11 and to the plane 32 (not shown in FIG. 7) which is defined by the longitudinal center axis 11 and the axes 13 and 16 of the rivet openings 12 and 15, respectively. The connecting link 34 has an elevation h₄ in the region of the leading rivet opening 12. This elevation h₄ is greater than the elevation h₅ in the region of the trailing rivet opening 15. The center region 23 has an elevation h₆ which is less than the elevation h₄ and less than the elevation h₅. The distance c₁ between the longitudinal center axis 11 and the forward running surface 21 is greater than the distance c₂ between the rearward running surface 22 and the longitudinal center axis 11. The distances (c₁, c₂) correspond to the distances (c₁, c₂) for the connecting link 4. All elevations (h₄, h₅, h₆) and the distances c₁ and c₂ are measured perpendicularly to the plane 32.

The connecting link 34 is configured to be mirror symmetrical to a plane 36 which contains the longitudinal center axis 11. The longitudinal center axis 11 runs perpendicularly to the axes 13 and 16 of the rivet openings 12 and 15 and this longitudinal center axis 11 runs in the plane of the base body 24. The connecting link 34 can be arranged on both sides of the saw chain 1 because of the symmetrical configuration. The head of a rivet bolt, which is arranged in the rivet openings 12 and 15, lies once on the outer side 26 and, for an arrangement on the opposite-lying side of the saw chain 1, lies on the inner side 27 which, in this case, is directed outwardly.

A further embodiment of a connecting link 44 is shown in FIGS. 9 to 11. The connecting link 44 corresponds essentially to the connecting link 34. The same reference numerals identify like elements of the connecting link. On its upper end 35, the connecting link 44 has a bevel 45 which extends over the entire length of the upper end 35. As shown in FIG. 10, the bevel 45 is arranged on the outer side 26 of the connecting link 44. The connecting link 44 has an impression 20 on the outer side 26 as well as on the inner side 27. The impression 20 has a depth t₂ which corresponds to the depth t₂ of the connecting link 4 of FIG. 6. Both impressions 20 are arranged symmetrically to the plane 36. The impressions 20 are configured as arrows and both point in the same direction, namely, they point in running direction 5. However, an unsymmetrical arrangement and configuration can be provided because the impressions 20 form no functional regions of the connecting link 44. The bevel 45 also defines no functional region of the connecting link 44; instead, the bevel 45 functions as a marking for the sorting and for the orientation of the connecting link 44.

As FIG. 11 shows, the rivet openings 12 and 15 of the connecting link 44 have respective bevels 14 and 17 whose widths b₃ are identical on the outer side 26 and the inner side 27 of the connecting link 44. The rivet openings 12 and 15 with the bevels 14 and 17 are configured symmetrically to the plane 36 of the connecting link 44 shown in FIG. 10. The running surfaces 21 and 22, which likewise define functional regions, extend over the entire width of the connecting link 44 measured perpendicularly to the plane 36 so that the running surfaces 21 and 22 are also configured symmetrically to plane 36. The functional regions of the connecting link 44 are configured symmetrically to the plane 36. For this reason, the connecting link 44 can be arranged on both longitudinal sides of the saw chain 1. In the arrangement on the right side of the saw chain 1 viewed from the running direction 5, the outer side 26 lies outside and the inner side 27 lies inside next to a drive link 2. In the arrangement on the left longitudinal side of the saw chain 1 seen in the running direction 5, the outer side 26 lies inside and the inner side 27 of the connecting link 44 is directed outwardly. Because the impressions 20 and the bevels 45 are configured as recesses of the base body 24 and do not project beyond the plane of the base body 24, the configuration and arrangement of the impressions 20 and of the bevels 45 are irrelevant for the arrangement of the connecting link 44 on a saw chain 1. An impression 20 is arranged on each side (26, 27). For this reason, it is visible to the operator whether the connecting link 44 is assembled in the correct orientation on the saw chain. It can also be provided that a connecting link 44 has only one bevel 45 or another recess on the base body 24 which is visible from the outside and that no impression 20 is provided in the base body 24 of the connecting link. 44.

It is understood that the foregoing description is that of the preferred embodiments of the invention and that various changes and modifications may be made thereto without departing from the spirit and scope of the invention as defined in the appended claims.

What is claimed is:

1. A connecting link for a saw chain of a motor-driven chain saw, the connecting link comprising:
a flat base body having first and second rivet openings defining first and second rivet opening axes;
said flat base body defining a longitudinal middle axis running through said flat base body and intersecting said first and second rivet opening axes;
said longitudinal middle axis and said first and second rivet opening axes conjointly defining a plane; and, said flat base body having functional regions mirror symmetrical to said plane.

2. The connecting link of claim 1, wherein said flat base body has an outer side and an inner side; each of said rivet openings has first and second bevels on said outer and inner sides, respectively; and, said first and second bevels have the same width (b₃) measured parallel to the corresponding rivet opening axis.

3. The connecting link of claim 1, wherein said plane is a first plane; and, said connecting link is configured to be mirror symmetrical with respect to a second plane perpendicular to said first and second rivet opening axes.

4. The connecting link of claim 1, wherein said plane is a first plane; and, said connecting link is configured to be mirror symmetrical with respect to a second plane containing said longitudinal middle axis and said first and second rivet opening axes.

5. The connecting link of claim 4, wherein said base body has an outer side and an inner side; each of said rivet openings has a countersink at said outer side and a bevel at said inner side; said countersink has a first width (b₁) measured parallel to the corresponding rivet opening axis; said bevel has a second width (b₂); and, said first width (b₁) is greater than said second width (b₂).

6. The connecting link of claim 1, wherein said saw chain runs in a predetermined running direction and said first rivet opening lies forward of said second rivet opening viewed in said running direction; said connecting link has a first elevation in the region of said first rivet opening measured perpendicularly to said first rivet opening axis and said longitudinal middle axis; said connecting link has a second elevation in the region of said second rivet opening measured perpendicularly to said second rivet opening axis and said longitudinal middle axis; and, said first elevation is less than said second elevation.

7. The connecting link of claim 1, wherein said saw chain runs in a predetermined running direction and said first rivet opening lies forward of said second rivet opening viewed in said running direction; said connecting link has a first elevation in the region of said first rivet opening measured perpendicularly to said first rivet opening axis and said longitudinal middle axis; said connecting link has a second elevation in the region of said second rivet opening measured perpendicularly to said second rivet opening axis and said longitudinal middle axis; said base body has a region disposed between said rivet openings; and, said flat base body has an elevation at said region which is less than said first elevation and less than said second elevation.

8. The connecting link of claim 1, wherein said saw chain runs in a predetermined running direction and said first rivet opening lies forward of said second rivet opening viewed in said running direction; said connecting link has a forward running surface adjacent said first rivet opening and a rearward running surface adjacent said second rivet opening; said forward and rearward running surfaces have first and second lengths, respectively; and, said second length is longer than said first length.

9. The connecting link of claim 8, wherein said forward running surface extends parallel to said longitudinal middle axis.

10. The connecting link of claim 8, wherein said forward running surface and said rearward running surface conjointly define an angle (α).

11. The connecting link of claim 10, wherein said angle (α) opens rearwardly referred to said predetermined running direction.

12. The connecting link of claim 10, wherein said angle (α) lies in a range from 1° to 5°.

13. The connecting link of claim 8, wherein said forward running surface has a maximum distance (c₁) to said longitudinal middle axis and said second running surface has a maximum distance (c₂) to said longitudinal middle axis: and, said maximum distance (c₁) of said forward running surface is greater than said maximum distance (c₂) of said rearward running surface.

14. The connecting link of claim 8, wherein said flat base body has a top end facing away from said forward and rearward running surfaces; and, said top end extends evenly.

15. The connecting link of claim 14, wherein said top end extends parallel to said longitudinal middle axis.

16. The connecting link of claim 1, wherein said flat base body has a depression formed therein.

17. The connecting link of claim 16, wherein said depression is disposed between said first and second rivet openings and is configured as an impression and material of said flat base body is compressed in the region of said impression.

18. The connecting link of claim 17, wherein said impression is intersected by said plane.

19. The connecting link of claim 17, wherein said saw chain runs in a predetermined running direction; and, said impression has the form of an arrowhead which points in said predetermined running direction.

20. The connecting link of claim 19, wherein said flat base body has said first and second sides and said impression is a first impression formed in said first side and said flat base body has a second impression formed in said second side; and, said first and second impressions both point in the same direction.

21. The connecting link of claim 16, wherein said depression is configured as a bevel.
